(19) United States
(12) Patent Application Publication
(10) Pub. No.: US 2002/0023980 A1
(43) Pub. Date: Feb. 28, 2002

(54) Spinning reel for fishing

(75) Inventors: Kazuyuki Matsuda, Tokyo (JP); Wataru Tsutsumi, Saitama (JP)

Correspondence Address: SUGHRUE, MION, ZINN, MACPEAK & SEAS, PLLC, 2100 Pennsylvania Avenue, N.W., Washington, DC, 20037, US

(73) Assignee: DAIWA SEIKO, INC.

(21) Appl. No.: 09/943,351

(22) Filed: Aug. 31, 2001

(30) Foreign Application Priority Data
Aug. 31, 2000 (JP) P.2000-262151
Feb. 23, 2001 (JP) P.2001-048913

(51) Int. Cl. A01K 89/015

(52) U.S. Cl. 242/319; 242/310; 242/224; D22/140

(57) ABSTRACT

A fishing reel having an elastic seal member for preventing liquid from entering provided between opposed members of the fishing reel, the elastic seal member includes: a first elastic working portion which comes in contact with one of the opposed members; an attachment portion attached to the other opposed member; and a second elastic working portion between the first elastic working portion and the attachment portion. The second elastic working portion permits deformation thereof during the contact.

### BACKGROUND OF THE INVENTION

The present invention relates to an improvement in a fishing reel which can enhance a water resistance and a dust resistance to a braking member and a bearing which are accommodated in a spool or a reel body.

Japanese Utility Model No. 2562713 and JP-A-11-196729 have disclosed a fishing reel in which the fishing reel is to be used in a fishing place in a decent and severe environment where salt water, water, sand dust and foreign matters easily stick and enter, thus, a reel body is formed of a material having a high corrosion resistance and is subjected to surface treatment, and further in order to prevent the salt water, water, sand, dust and foreign matters from entering the reel body and to cause each member to function without a hindrance, a spool accommodated in a braking device has a waterproof and dust proof structure.

The Japanese Utility Model No. 2562713 has disclosed such a structure that an elastic seal member is provided between the front face of an opening formed ahead of a spool and the rear face of a drag knob. The JP-A-11-196729 has disclosed such a structure that a seal member to come in contact with a spool is provided between the rear face of a drag knob and the front face of a braking plate. These seal members can prevent impurities from entering the inside of a controller.

However, the salt water, the water, the sand, the dust and the foreign matters easily enter and stick and are readily accumulated through a gap formed between the front face of the spool and the drag knob. Therefore, the waterproof degree is insufficient so that a drag performance is deteriorated or the impurities sticking to the inside are to be removed, and furthermore, the work for moving it cannot be easily carried out in the fishing place.

The former case discloses such structure that one dish-shaped seal plate is provided slidably in contact with a concave portion on the front face of the spool, and the latter case discloses such structure that the inner peripheral surface of a spool ring color in the latter case. In these structures, when a deflection or deformation is caused between a spool and a drag knob in opposite members or a spool ring collar and a second member having a seal plate attached thereto, in order to raise contact pressure in the sliding contact portion of the seal plate to permit the deflection, a countermeasure is taken, that is, a thickness is increased or a contact amount (area) is increased. If the thickness is increased, rotation becomes slow so that an operation for regulating drag force cannot be carried out smoothly.

In the structure of a double bearing type reel in which the dish-shaped seal plate is provided between a drag braking regulation knob and a reel body, if rotation becomes slow for the same reason as that described above, a contact resistance in the direction of rotation of a handle shaft is increased so that an operation for winding and rotating a line cannot be carried out lightly.

If the sliding contact portion is thinned to perform the smooth rotation, a portion having a low contact pressure is generated so that a water resistance cannot be obtained.

Moreover, there is a problem in that the use for a long period of time promotes the wear and damage of the sliding contact portion of the seal plate by the influence of a high contact resistance so that a sufficient waterproof performance cannot be maintained stably.

The problem to be solved is as follows. In the waterproof structure in which one dish-shaped seal plate is provided between opposed members, a countermeasure is taken so that the thickness is increased or the contact amount is increased in order to raise the contact pressure of the sliding contact portion of the seal plate to permit the deflection or deformation to be caused between the opposed members. If the thickness is increased, the rotation becomes slow so that the operation for regulating drag force cannot be carried out smoothly. In the drag braking regulation knob, moreover, the contact resistance to the direction of rotation of the handle shaft is increased so that the operation for winding and rotating the line cannot be carried out lightly.

There is such a drawback that a portion having a low contact pressure is formed and the water resistance cannot be obtained if the thickness of the sliding contact portion is reduced to carry out the rotation lightly.

### SUMMARY OF THE INVENTION

In consideration of the drawbacks, it is an object of the invention to provide a fishing reel capable of absorbing a deflection or deformation caused between opposed members through an elastic seal member, thereby obtaining a light rotation performance and a high stable waterproof performance.

In order to solve the aforesaid object, the invention is characterized by having the following arrangement.

(1) A fishing reel having an elastic seal member for preventing liquid from entering provided between opposed members of the fishing reel, the elastic seal member includes:

an elastic working portion which comes in contact with one of the opposed members;

an attachment portion attached to the other opposed member; and

an intermediate portion between the elastic working portion and the attachment portion,

wherein the elastic working portion is formed more thickly than at least the intermediate portion.

(2) The fishing reel according to (1), wherein the intermediate portion is formed thinly.

(3) The fishing reel according to (1), wherein the elastic seal member is formed of hard rubber.

(4) The fishing reel according to (1), wherein the elastic seal member is annular.

(5) The fishing reel according to (1), wherein the elastic seal member includes a coupling portion between the intermediate portion and the attachment portion, and the coupling portion makes an acute angle with the intermediate portion.

(6) The fishing reel according to (1), wherein the intermediate portion includes a bellows shape portion.

(7) The fishing reel according to (1), wherein a tip of the elastic working portion is formed in a bulged shape.

(8) A fishing reel having an elastic seal member for preventing liquid from entering provided between opposed members of the fishing reel, the elastic seal member comprising:

a first elastic working portion which comes in contact with one of the opposed members;

an attachment portion attached to the other opposed member; and

a second elastic working portion between the first elastic working portion and the attachment portion, which permits deformation thereof during the contact.

(9) The fishing reel according to (8), wherein the second elastic working portion is formed thinly.

(10) The fishing reel according to (8), wherein a high elastic portion is formed between the first elastic working portion and the second elastic working portion.

(11) The fishing reel according to (8), wherein the elastic sealing member is annular.

(12) The fishing reel according to (8), wherein the elastic sealing member is formed of hard rubber.

(13) The fishing reel according to (8), wherein the first elastic working portion makes an acute angle with the second elastic working portion.

(14) The fishing reel according to (8), wherein the second elastic working portion is formed of a softer rubber than a material of each of the first elastic working portion and the attachment portion.

### BRIEF DESCRIPTION OF THE DRAWINGS

FIG. 1 is a sectional view showing the main part of a spool and a spool shaft in the fishing reel and a partially enlarged sectional view according to a first embodiment.

FIG. 2 is an exploded sectional view showing the spool.

FIG. 3 is an enlarged sectional view showing the spool shaft and a spool support member.

FIG. 4 is an enlarged plan view showing a press member.

FIG. 5 is an enlarged plan view showing a click engagement member.

FIG. 6 is a partially enlarged sectional view showing a spool and a spool shaft in the fishing reel according to a second embodiment.

FIG. 7 is a partially enlarged sectional view showing a spool and a spool shaft in the fishing reel according to a third embodiment.

FIG. 8 is a partially enlarged sectional view showing a spool and a spool shaft in the fishing reel according to a fourth embodiment.

FIG. 9 is a partially enlarged sectional view showing a spool and a spool shaft in the fishing reel according to a fifth embodiment.

FIG. 10 is a partially enlarged sectional view showing a spool and a spool shaft in the fishing reel according to a sixth embodiment.

FIG. 11 is a sectional view showing a partially enlarged sectional view of a spool and a spool shaft in the fishing reel according a seventh embodiment.

FIG. 12 is a sectional view showing a partially enlarged sectional view of a spool and a spool shaft in the fishing reel according to an eighth embodiment.

FIG. 13 is a sectional view showing a partially enlarged sectional view of a spool and a spool shaft in the fishing reel according to a ninth embodiment.

FIG. 14 is a sectional side view showing a fishing spinning reel according to a tenth embodiment.

FIG. 15 is an enlarged sectional side view showing the front side of a reel body.

FIG. 16 is an enlarged sectional side view showing a rear side reel body and a drag regulating member.

FIG. 17 is a side view showing a braking metal member.

FIG. 18 is a sectional side view showing the line guide portion of a fishing spinning reel according to the eleventh embodiment.

FIG. 19 is an exploded sectional side view showing the line guide portion.

FIG. 20 is a sectional side view showing a fishing spinning reel according to twelfth embodiment.

FIG. 21 is an enlarged sectional side view showing a rear side reel body and a drag regulating member.

FIG. 22 is a sectional rear view showing a motor reel according to a thirteenth embodiment.

FIG. 23 is an enlarged sectional rear view showing the motor reel on the handle side and a sectional rear view showing the main part thereof.

FIG. 24 is an enlarged sectional rear view showing the motor reel on the handle side and a sectional rear view showing the main part thereof according to a fourteenth embodiment.

### DETAILED DESCRIPTION OF PREFERRED EMBODIMENT

The invention will be described below based on embodiments shown in the drawings.

### First Embodiment

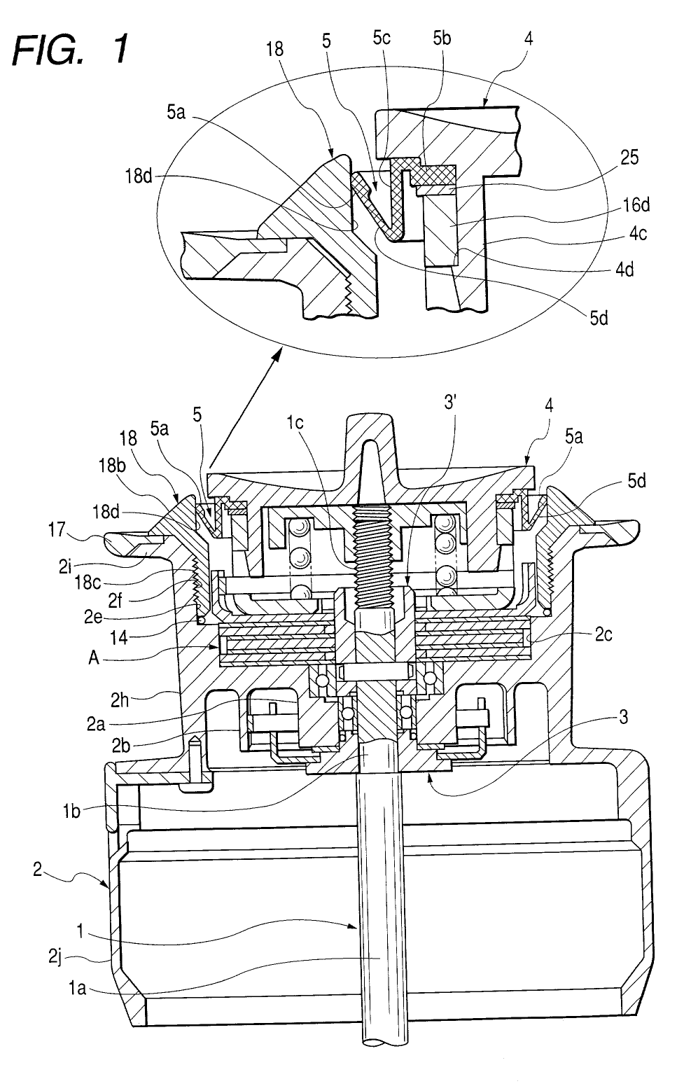

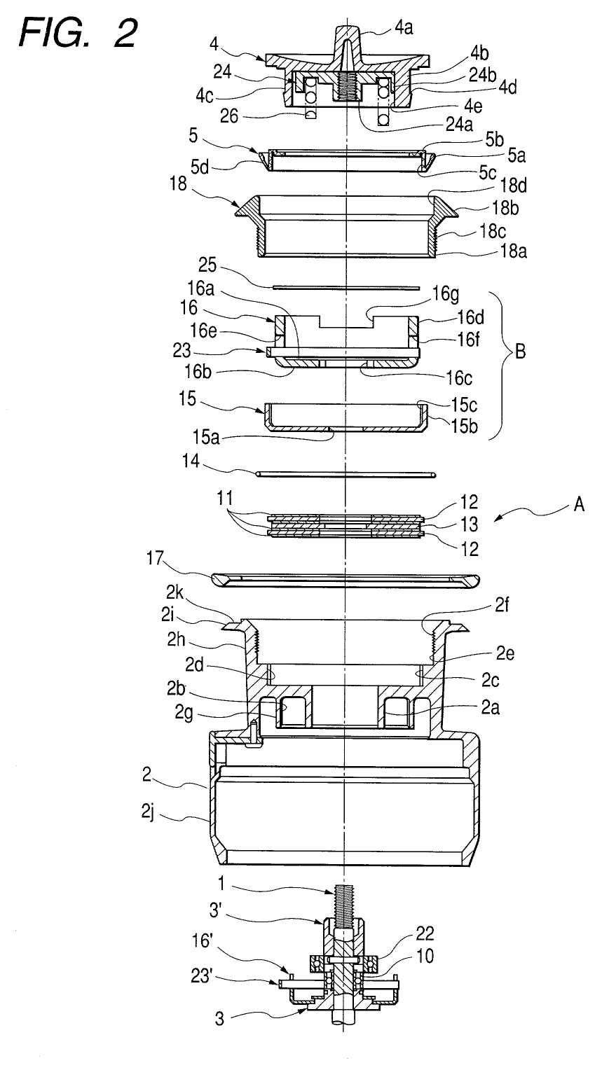

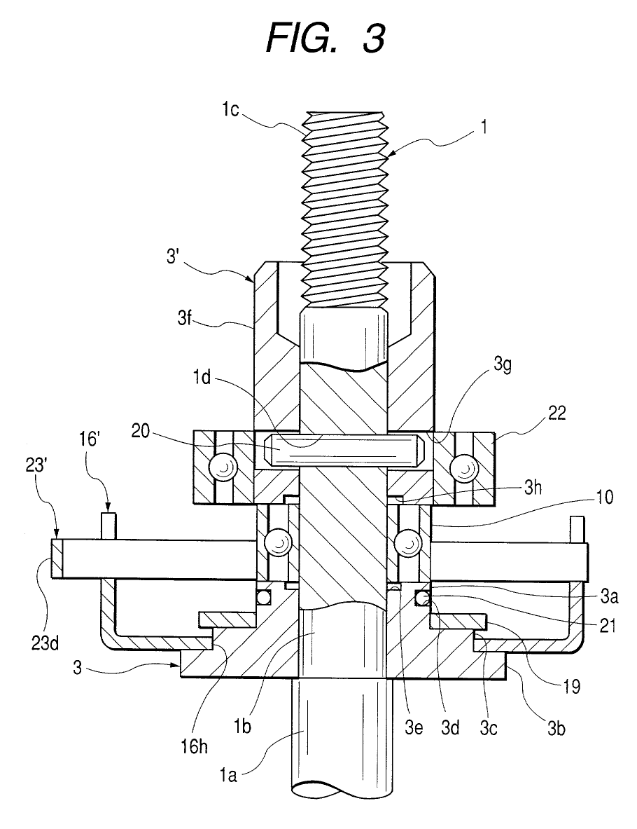

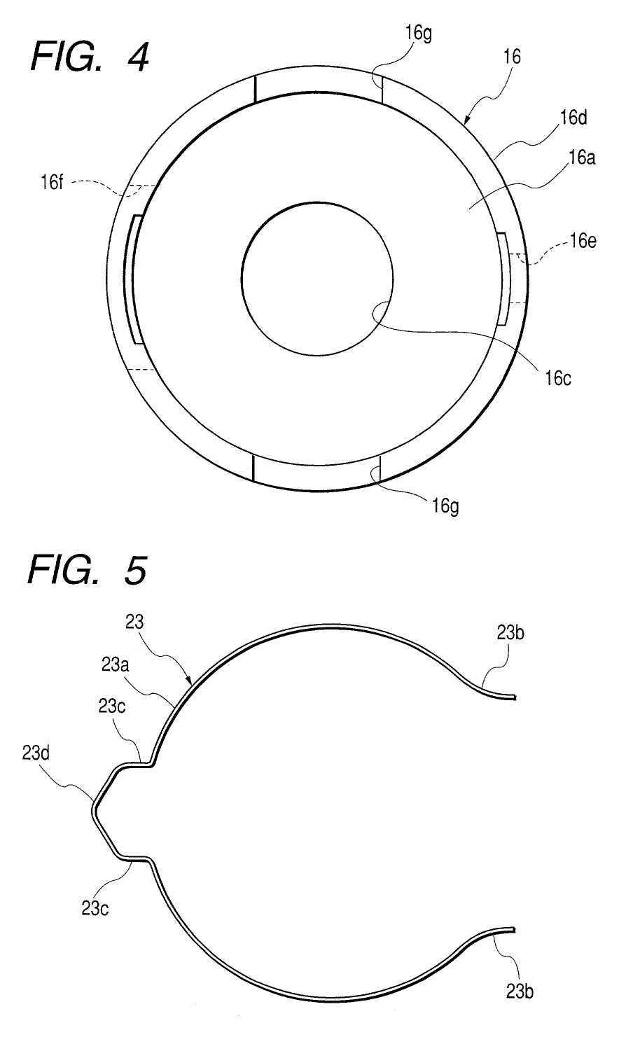

FIGS. 1 to 5 show a spinning reel for fishing using a front drag method according to a first embodiment. FIG. 1 is a sectional view showing the main part of a spool and a spool shaft in the fishing reel and a partially enlarged sectional view, FIG. 2 is an exploded sectional view showing the spool, FIG. 3 is an enlarged sectional view showing the spool shaft and a spool support member, FIG. 4 is an enlarged plan view showing a press member, and FIG. 5 is an enlarged plan view showing a click engagement member.

In the fishing spinning reel, a spool 2 is attached to the tip of a spool shaft 1 supported on a reel body which is not shown and protruded toward the front side. The spool shaft 1 is prevented from rotating with respect to the reel body.

The spool shaft 1 is provided with a large diameter portion 1a, a small diameter portion 1b which is formed on an end of the large diameter portion 1a as a step portion and has a smaller diameter than the diameter of the large diameter portion 1a, and a screw portion 1c formed on a tip thereof.

A hole 1d perpendicular to an axial direction is formed through the small diameter portion 1b.

A cylindrical spool support member 3, a bearing 10 and a cylindrical spool support member 3′ are fitted in the outer periphery of the small diameter portion 1b.

The spool 2 comprises an inside shaft cylinder portion 2a, a cylinder portion 2b having a larger diameter than the diameter of the inside shaft cylinder portion 2a, an opening housing portion 2c for a breaking member A to be a concave portion on the front side of the inside shaft cylinder portion 2a, a plurality of axial vertical grooves 2d provided on the peripheral surface of the opening housing portion 2c, an opening 2e comprising a concave portion provided,on the front side of the opening housing portion 2c, a screw portion 2f provided on the peripheral surface of the opening 2e, a click concave-convex tooth 2g provided on the inner periphery of the cylinder portion 2b having a large diameter, a line winding drum portion 2h on the outer periphery upon which a line is to be wound, a front flange portion 2i and a rear cylinder portion 2j having a large diameter.

The braking member A comprises the friction plate 11, a braking plate 13, the friction plate 11, the braking plate 12 and the friction plate in order. The braking member A is accommodated in the opening housing portion 2c. An elastic seal member 14 formed by an O ring, a dish-shaped ratchet ring 15 of a click mechanism B and a press member 16 comprising a dish-shaped click engagement holder are accommodated the an opening 2e.

A step portion 2k is formed on the front side of the front flange portion 2i. A hard ring-shaped flange portion 17 is superposed on the flange portion 2i to be fitted in the step portion 2k and is fixed with a nut member 18.

In the spool support member 3, two-step flange portions 3b and 3c are formed on the rear end of a cylinder portion 3a, a peripheral groove 3d is formed on the front side of the flange portion 3c, and a relief concave portion 3e is formed on the inside thereof.

A friction plate 19 is fitted in the outer periphery of the cylinder portion 3a on the front side of the flange portion 3c.

The spool support member 3′ has a hole 3g perpendicular to an axial direction formed through a cylinder portion 3f.

A relief concave portion 3h is formed on the inside of the rear end of the cylinder portion 3f.

An engagement pin 20 is removably inserted in the hole 3g and the hole 1d.

An elastic seal member 21 comprising an O ring is fitted in the peripheral groove 3d of the cylinder portion 3a of the spool support member 3.

A bearing 22 is fitted in the outer periphery of the cylinder portion 3f of the spool support member 3′.

The inside shaft cylinder portion 2a of the spool 2 is fitted in the outer periphery of each of the bearings 10 and 22. The friction plate 11, a braking plate 13, the friction plate 11, the braking plate 12 and the friction plate of the braking member A, and the dish-shaped ratchet ring 15 and a press member 16 comprising a dish-shaped click engagement holder of a click mechanism B are fitted in the outer periphery of the cylinder portion 3f provided on the front side of the inside shaft cylinder portion 2a of the spool 2.

A projection provided on the outer periphery of each braking plate 12 is engaged with the vertical groove 2d of the spool 2 so that the braking plate 12 is prevented from rotating with respect to the spool 2.

A central hole of the braking plate 13 and a central hole 15a of the dish-shaped ratchet ring 15 are fitted into the outer periphery of the cylinder portion 3f of the spool support member 3′ and prevented from rotating with respect to the spool support member 3′.

The hole 1d of the spool shaft 1 in which the engagement pin 20 is removably inserted and the hole 3g of the spool support member 3′ are blocked by the bearing 22.

The dish-shaped ratchet ring 15 has the central hole 15a formed on the center of a bottom surface and a click concave-convex tooth 15c formed on the inner periphery of an outer peripheral wall 15b.

As shown in FIGS. 1 to 3, the press member 16 comprising the dish-shaped click engagement holder is formed by an inside bottom surface 16a, an outside press face 16b of the bottom surface 16a, a central hole 16c of the bottom surface 16a, an outer peripheral wall 16d,holes 16e and 16f provided on the outer peripheral wall 16d, and notches 16g an 16g for preventing rotation.

A click engagement member 23 is attached into the press member 16 comprising the click engagement holder.

As shown in FIG. 5, the click engagement member 23 is formed by a circular arc portion 23a, engagement portions 23b and 23b obtained by opening the circular arc portion 23a, parallel sliding guide portions 23c and 23c, and an angular inclined portion 23d.

The click engagement member 23 is inserted in the outer peripheral wall 16d of the press member 16 comprising the click engagement holder so that the sliding guide portions 23c and 23c, the angular inclined portion 23d are inserted into the hole 16e and the engagement portions 23b and 23b are engaged with opposite edges in the hole 16f.

The angular inclined portion 23d is engaged with the click concave-convex tooth 15c formed on the inner periphery of the outer peripheral wall 15b of the dish-shaped ratchet ring 15.

The press member 16 comprising the click engagement holder is attached to a drag regulating member 4, and an annular elastic seal member 5 is interposed between the drag regulating member 4 and the press member 16 comprising the click engagement holder.

The drag regulating member 4 is attached to the spool shaft 1 by screwing a nut portion 24a of a nut member 24 into the screw portion 1c on the tip of the spool shaft 1. The nut member 24 is fitted on and is prevented from rotating with respect to the inside of the drag regulating member 4.

The nut member 18 is formed by a cylinder portion 18a, a flange portion 18b, a screw portion 18c on the outer periphery of the cylinder portion 18a, and an opening 18d to be a concave portion on the inside of the flange portion 18b.

The screw portion 18c is screwed to the screw portion 2f of the spool 2 and the elastic seal member 14 comprising an O ring is pressed by the tip of the cylinder portion 18a.

The annular elastic seal member 5 interposed between the drag regulating member 4 and the press member 16 comprising the click engagement holder is caused to slidably come in contact with the inner peripheral surface of the edge portion of the opening 18d of the nut member 18.

The annular elastic seal member 5 is formed of hard rubber and includes a thick elastic working portion 5a, an attachment portion 5b, a coupling portion 5c, and a thin intermediate portion 5d between the elastic working portion 5a and the attachment portion 5b.

The thick elastic working portion 5a and the thin intermediate portion 5d are formed to have an inverted conical shape with respect to the coupling portion 5c in a vertical direction. The outside of the thick elastic working portion 5a is formed on the same level with the outside of the thin intermediate portion 5d.

The outside of the tip of the elastic working portion 5a is caused to slidably come in contact with the inner peripheral surface of the edge portion of the opening 18d of the nut member 18 which is one of the opposed member. The attachment portion 5b is interposed between the drag regulating member 4 which is the other opposed member and the press member 16 comprising the click engagement holder with a washer 25 provided therebetween. The intermediate portion 5d is formed thinly to permit the deformation of the elastic working portion 5a during the contact.

The drag regulating member 4 includes a knob operating portion 4a formed on a surface thereof, a cylinder portion 4b and several arm portions 4c formed on a back face thereof, and a hook portion 4d formed on the tip of the arm portion 4c.

The hook portion 4d is engaged with the holes 16e and 16f of the press member 16 comprising the click engagement holder so that the drag regulating member 4, the annular elastic seal member 5 and the press member 16 comprising the click engagement holder are integrated.

A rotation prevention face 4e is formed on the internal surface of the cylinder portion 4b and an engaged face 24b formed on the nut member 24 is engaged therewith.

A spring 26 is inserted between the nut member 24 and the bottom surface 16a of the press member 16 comprising the dish-shaped click engagement holder.

A central hole 16h of a dish-shaped click engagement holder 16′ having almost the same shape as that of the press member 16 comprising the dish-shaped click engagement holder is fitted in and prevented from rotating with respect to the outer periphery of the flange portion 3c of the spool support member 3. A click engagement member 23′ having almost the same shape as that of the click engagement member 23 is attached into the dish-shaped click engagement holder 16′.

An angular inclined portion 23d of the click engagement member 23′ is engaged with the click concave-convex tooth 2g of the spool 2.

When the spool 2, the braking member A and the click mechanism B integrated with the drag regulating member 4 are incorporated in the tip of the spool shaft 1, the cylindrical spool support member 3, the bearing 10 and the cylindrical spool support member 3′ are fitted in the outer periphery of the small diameter portion 1b of the spool shaft 1 so that the engagement pin 20 is inserted in the hole 3d and the hole 1d and the bearing 22 is fitted in the outer periphery of the cylinder portion 3f of the spool support member 3′.

Next, the braking member A and the click mechanism B integrated with the drag regulating member 4 are fitted in the outer periphery of the cylinder portion 3f of the spool support member 3′ so that the nut portion 24a of the nut member 24 on the inside of the drag regulating member 4 is screwed into the screw portion 1c on the tip of the spool shaft 1.

As described above, the tip of the thick elastic working portion 5a of the annular elastic seal member 5 is caused to slidably come in contact with the inner peripheral surface of the edge portion of the opening 18d of the nut member 18 which is the one of the opposed members acting as a rotor by the rotation in which the line on the sliding side is fed from the spool. The attachment portion 5b is interposed between the drag regulating member 4 which is the other opposed member on the fixing side and the press member 16 comprising the click engagement holder with the washer 25 provided therebetween. The intermediate portion 5d is formed thinly to permit the deformation of the elastic working portion 5a during the contact. Therefore, a deflection or deformation caused between one of the opposed members and the other opposed member can be absorbed by the elastic deforming action of the intermediate portion 5d formed in the intermediate part of the elastic seal member 5.

The intermediate portion 5d is formed thinly to permit the deformation during the contact. Therefore, it is possible to sufficiently maintain the contact pressure of the elastic working portion 5a to the peripheral surface of the member.

With the above structure of the fishing reel, the elastic working portion 5a of the annular elastic seal member 5 is formed thickly and the intermediate portion 5d is formed more thinly than the elastic working portion 5a and the attachment portion 5b. Consequently, even if a deflection or eccentricity is present between the drag regulating member 4 which is one of the opposed members on the fixing side where the attachment portion 5b is fixed, and the press member 16 comprising the click engagement holder and the inner peripheral surface of the edge portion of the opening 18d of the nut member 18 which is the other opposed member acting as the rotor by the rotation for feeding, from the spool, the line on the sliding side with which the elastic working portion 51 is caused to slidably come in contact, the thick elastic working portion 5a easily conforms to the rotor and the contact pressure of the elastic working portion 5a can be reduced. Therefore, a rotation resistance can be reduced and the rotor can be rotated smoothly so that a light rotation performance and a high waterproof performance can be obtained.

The intermediate portion 5d is formed more thinly than the elastic working portion 5a and the attachment portion 5b. Consequently, the eccentricity or deflection caused between the elastic working portion 5a and the attachment portion 5b can be removed more effectively. Even if the contact pressure is reduced, the elastic working portion can conform to the rotor more easily.

### Second Embodiment

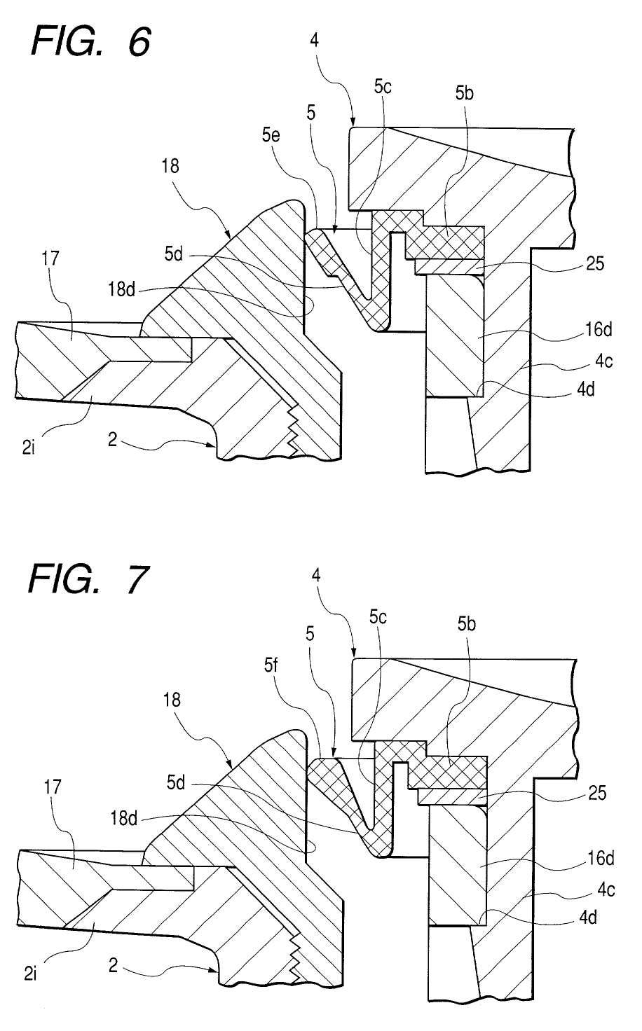

FIG. 6 shows a fishing spinning reel using a front drag method according to a second embodiment. FIG. 6 is a partially enlarged sectional view showing a spool and a spool shaft in the fishing reel.

In the second embodiment, an annular elastic seal member 5 is formed of hard rubber and includes a thick elastic working portion 5e, an attachment portion 5b,a coupling portion 5c, and a thin intermediate portion 5d between the elastic working portion 5e and the attachment portion 5b.

The thick elastic working portion 5e and the thin intermediate portion 5d are formed to have an inverted conical shape with respect to the coupling portion 5c in a vertical direction. The inside of the thick elastic working portion 5e is formed on the same level with the inside of the thin intermediate portion 5d.

Other structures are almost the same as those in the first embodiment.

### Third Embodiment

FIG. 7 shows a fishing spinning reel using a front drag method according to a third embodiment. FIG. 7 is a partially enlarged sectional view showing a spool and a spool shaft in the fishing reel.

In the third embodiment, an annular elastic seal member 5 is formed of hard rubber and includes a thick elastic working portion 5f, an attachment portion 5b, a coupling portion 5c, and a thin intermediate portion 5d between the elastic working portion 5f and the attachment portion 5b.

The thick elastic working portion 5f and the thin intermediate portion 5d are formed to have an inverted conical shape with respect to the coupling portion 5c in a vertical direction. A tip of the thick elastic working portion 5f is formed in a bulged shape.

Other structures are almost the same as those in the first embodiment.

### Fourth Embodiment

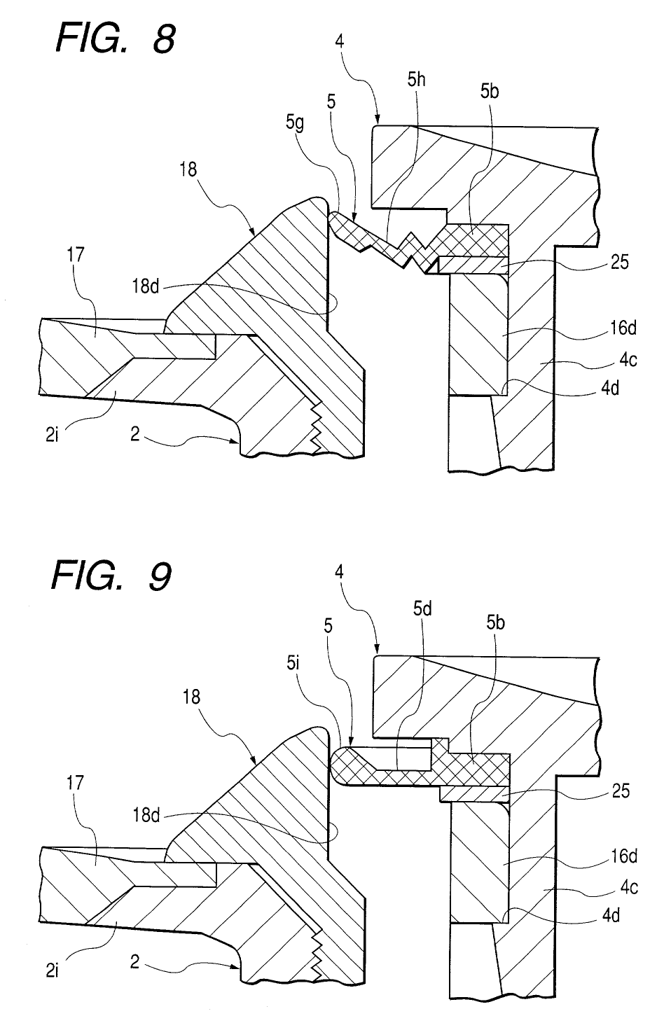

FIG. 8 shows a fishing spinning reel using a front drag method according to a fourth embodiment. FIG. 8 is a partially enlarged sectional view showing a spool and a spool shaft in the fishing reel.

In the fourth embodiment, an annular elastic seal member 5 is formed of hard rubber and includes a thick elastic working portion 5g, an attachment portion 5b, and a thin bellows-shaped intermediate portion 5h between the elastic working portion 5g and the attachment portion 5b.

Other structures are almost the same as those in the first embodiment.

### Fifth Embodiment

FIG. 9 shows a fishing spinning reel using a front drag method according to a fifth embodiment. FIG. 9 is a partially enlarged sectional view showing a spool and a spool shaft in the fishing reel.

In the fifth embodiment, an annular elastic seal member 5 is formed of hard rubber and includes a thick elastic working portion 5i, an attachment portion 5b, a thin intermediate portion 5d between the elastic working portion 5i and the attachment portion 5b. The elastic working portion 5i and the intermediate portion 5d are protruded from the attachment portion 5b in a horizontal direction.

The tip of the thick elastic working portion 5i is formed to have a bulged shape.

The underside of the thick elastic working portion 5i is formed on the same level with the underside of the thin intermediate portion 5d.

Other structures are almost the same as those in the first embodiment.

### Sixth Embodiment

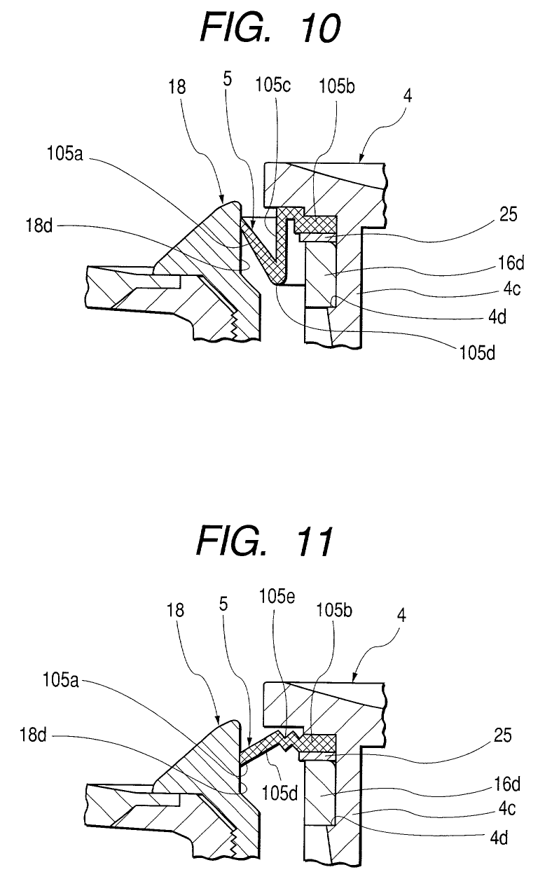

FIG. 10 shows a fishing spinning reel using a front drag method according to a sixth embodiment. FIG. 10 is a partially enlarged sectional view showing a spool and a spool shaft in the fishing reel.

In the sixth embodiment, an annular elastic seal member 5 is formed of hard rubber and includes a hook-shaped first elastic working portion 105a, an attachment portion 105b, a second elastic working portion 105c between the first elastic working portion 105a and the attachment portion 105b, and a thick coupling portion 105d between the first elastic working portion 105a and the second elastic working portion 105c.

The tip of the first elastic working portion 105a is caused to slidably come in contact with the inner peripheral surface of the edge portion of an opening 18d of a nut member 18 which is one of opposed members. The attachment portion 105b is interposed between a drag regulating member 4 which is the other opposed member and a press member 16 comprising a click engagement holder with a washer 25 provided therebetween. The second elastic working portion 105c is formed thinly to permit the deformation of the first elastic working portion 105a during the contact.

The thick coupling portion 105d is constituted to maintain the contact elastic pressure of the firs elastic working portion 105a.

As described above, the tip of the first elastic working portion 105a of the annular elastic seal member 5 is caused to slidably come in contact with the inner peripheral surface of the edge portion of the opening 18d of the nut member 18 which is one of the opposed members. The attachment portion 105b is interposed between the drag regulating member 4 which is the other opposed member and the press member 16 comprising the click engagement holder. The second elastic working portion 105c is formed thinly to permit the deformation of the first elastic working portion 105a during the contact. Therefore, a deflection or deformation caused between one of the opposed members and the other opposed member can be absorbed by the elastic deforming action of the second elastic working portion 105c formed in the intermediate portion of the elastic seal member 5.

Since the second elastic working portion 105c is formed thinly to permit the deformation during the contact, it is possible to sufficiently maintain the contact pressure of the first elastic working portion 105a to the peripheral surface of the member.

With the above structure of the fishing reel, the second elastic working portion 105c is formed thinly to permit the deformation of the first elastic working portion 105a during the contact, a deflection or deformation caused between one of the opposed members and the other opposed member can be absorbed by the elastic deforming action of the second elastic working portion 105c formed in the intermediate portion of the elastic seal member 5. Consequently, it is possible to obtain a light rotation performance and a high waterproof performance between the members.

Other structures are almost the same as those of the embodiments described above.

### Seventh Embodiment

FIG. 11 shows a fishing spinning reel using a front drag method according to a seventh embodiment. FIG. 11 is a sectional view showing a partially enlarged sectional view of a spool and a spool shaft in the fishing reel.

In the seventh embodiment, an annular elastic seal member 5 is formed by a hook-shaped first elastic working portion 105a, an attachment portion 105b, a second elastic working portion 105e between the first elastic working portion 105a and the attachment portion 105b, and a thick coupling portion 105d between the first elastic working portion 105a and the second elastic working portion 105e.

The tip of the first elastic working portion 105a is caused to slidably come in contact with the inner peripheral surface of the edge portion of an opening 18d of a nut member 18 which is one of opposed members. The attachment portion 105b is interposed between a drag regulating member 4 which is the other opposed member and a press member 16 comprising a click engagement holder with a washer 25 provided therebetween. The second elastic working portion 105e is bellows-shaped to permit the deformation of the first elastic working portion 105a during the contact.

Other structures are almost the same as those in the sixth embodiment.

### Eighth Embodiment

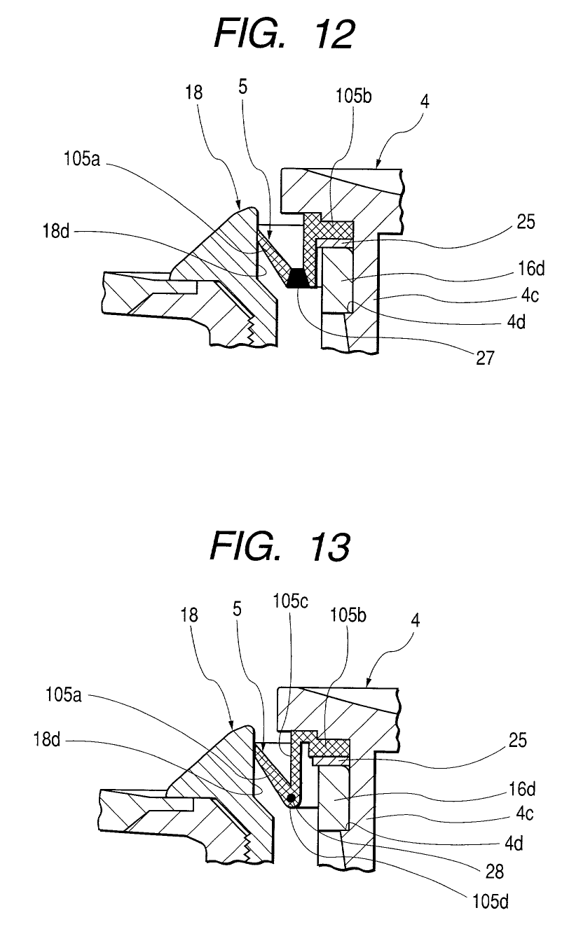

FIG. 12 shows a fishing spinning reel using a front drag method according to an eighth embodiment. FIG. 12 is a sectional view showing a partially enlarged sectional view of a spool and a spool shaft in the fishing reel.

In the twelfth embodiment, an annular elastic seal member 5 includes a hook-shaped first elastic working portion 105a, an attachment portion 105b, and a second elastic working portion 27 to be another member between the first elastic working portion 105a and the attachment portion 105b.

The second elastic working portion 27 is formed of an elastic member such as a softer rubber than the material of each of the first elastic working portion 105a and the attachment portion 105b, and is fixed integrally with the first elastic working portion 105a and the attachment portion 105b by welding, bonding or insert molding.

The tip of the first elastic working portion 105a is caused to slidably come in contact with the inner peripheral surface of the edge portion of an opening 18d of a nut member 18 which is one of opposed members. The attachment portion 105b is interposed between a drag regulating member 4 which is the other opposed member and a press member 16 comprising a click engagement holder with a washer 25 provided therebetween. The second elastic working portion 27 is so constituted as to permit the deformation of the first elastic working portion 105a during the contact.

Other structures are almost the same as those in the sixth embodiment.

### Ninth Embodiment

FIG. 13 shows a fishing spinning reel using a front drag method according to a ninth embodiment. FIG. 13 is a sectional view showing a partially enlarged sectional view of a spool and a spool shaft in the fishing reel.

In the ninth embodiment, an annular elastic seal member 5 is formed of hard rubber to include a hook-shaped first elastic working portion 105a, an attachment portion 105b, and a thin second elastic working portion 105c between the first elastic working portion 105a and the attachment portion 105b, and a high elastic member 28 formed of a metal which is inserted molded into a thick coupling portion 105d between the first elastic working portion 105a and the second elastic working portion 105c.

The tip of the first elastic working portion 105a is caused to slidably come in contact with the inner peripheral surface of the edge portion of an opening 18d of a nut member 18 which is one of opposed members. The attachment portion 105b is interposed between a drag regulating member 4 which is the other opposed member and a press member 16 comprising a click engagement holder with a washer 25 provided therebetween. The second elastic working portion 105c is so formed as to permit the deformation of the elastic working portion 105a during the contact.

Other structures are almost the same as those in the sixth embodiment.

As in the ninth embodiment, if the high elastic member 28 such as a metal member is insert molded in the thick coupling portion 105d of the first elastic working portion 105a and the second elastic working portion 105c, the contact pressure of the first elastic working portion 105a to the peripheral surface of the member can be sufficiently maintained and a stable waterproof performance can be obtained.

### Tenth Embodiment

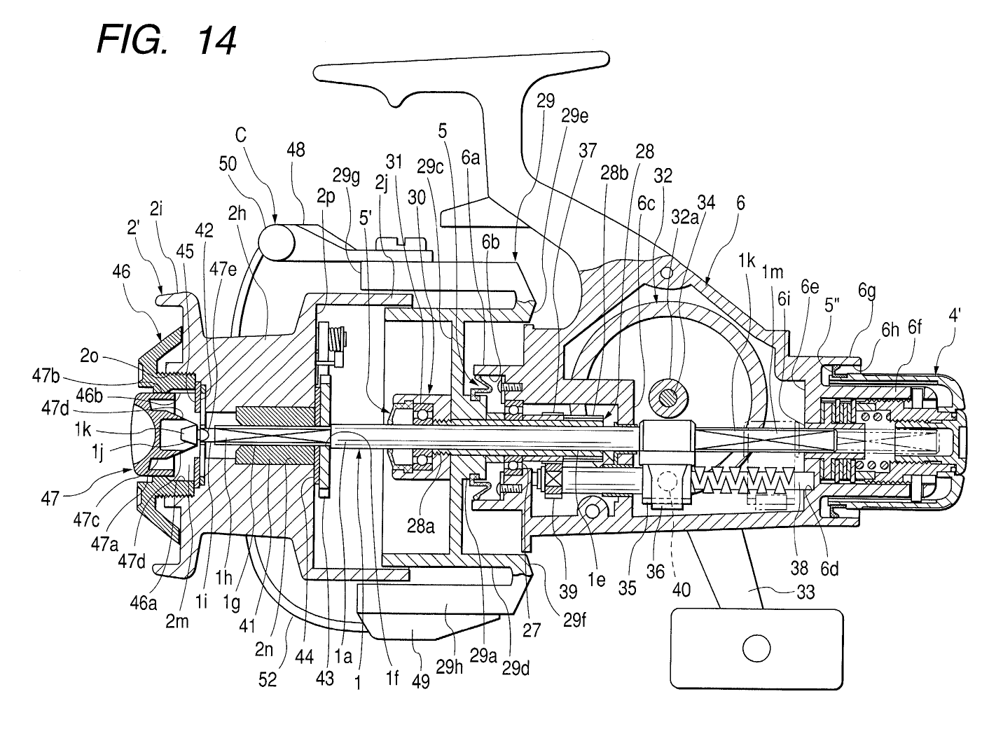

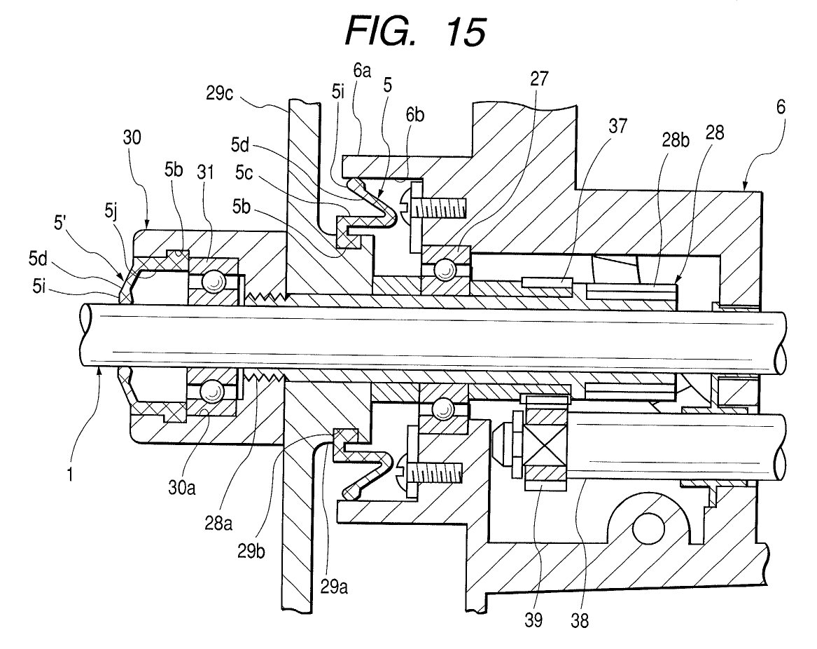

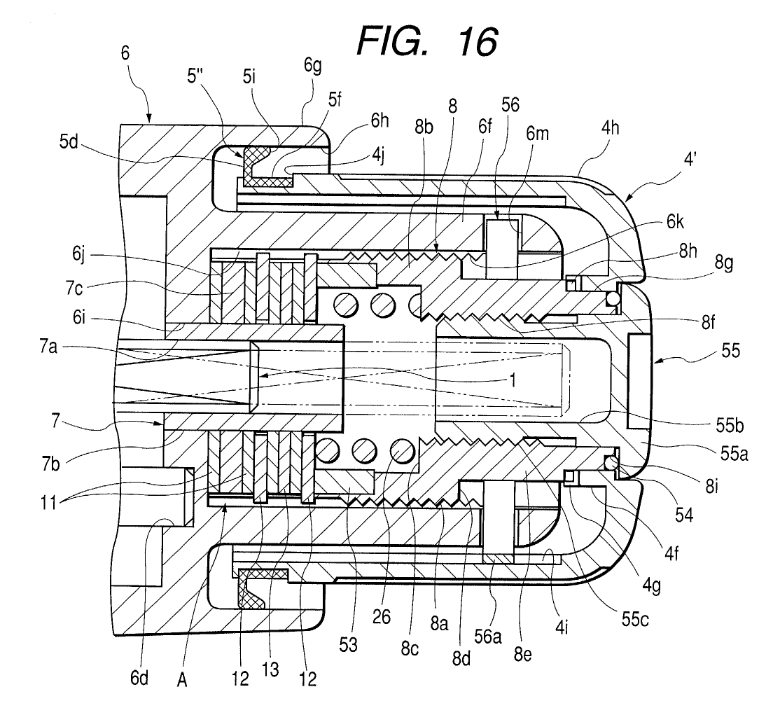

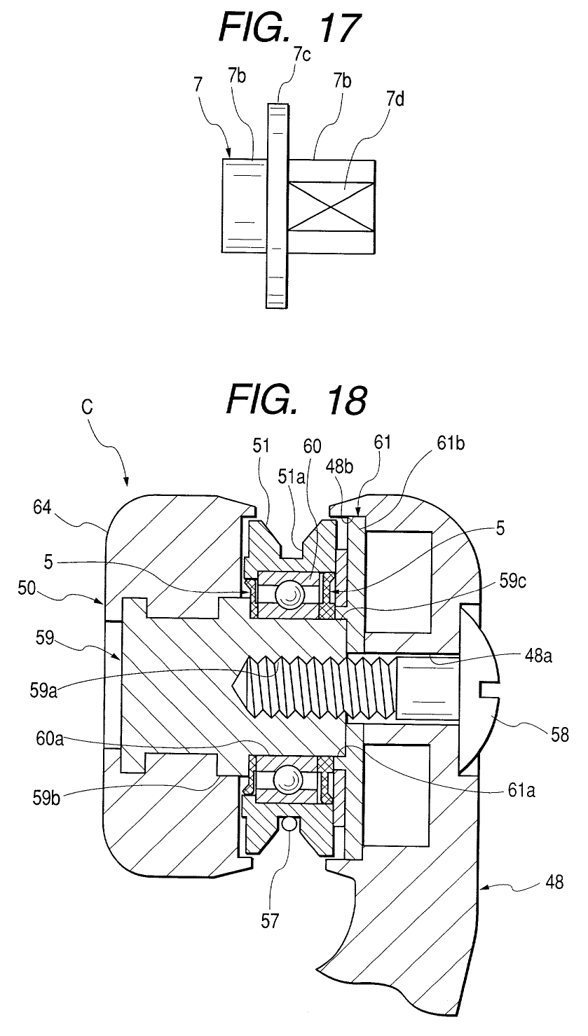

FIGS. 14 to 17 show a fishing spinning reel using a rear drag method according to a tenth embodiment. FIG. 14 is a sectional side view showing a fishing spinning reel, FIG. 15 is an enlarged sectional side view showing the front side of a reel body, FIG. 16 is an enlarged sectional side view showing a rear side reel body and a drag regulating member, and FIG. 17 is a side view showing a braking metal member.

In the fishing spinning reel, a rotary shaft cylinder 28 is rotatably received by a bearing 27 in the front part of the reel body 6 and is protruded forward from the reel body.

A cylinder portion 29a of a rotor 29 is engaged with and prevented from rotating with respect to the outer periphery of the rotary shaft cylinder 28 on the front side of the bearing 27 and is fixed to a screw portion 28a on the tip of the rotary shaft cylinder 28 with a cap nut 30.

A cylinder portion 6a having a large diameter is formed in the front part of the reel body 6.

A peripheral groove 29b is formed on the outer periphery of the cylinder portion 29a of the rotor 29 and an attachment portion 5b of an annular elastic seal member 5 is fitted therein.

The annular elastic seal member 5 is formed of hard rubber to include a thick elastic working portion 5i, the attachment portion 5b, a coupling portion 5c, and a thin intermediate portion 5d between the elastic working portion 5i and the attachment portion 5b.

The thick elastic working portion 5i and the thin intermediate portion 5d are formed to have an inverted conical shape with respect to the coupling portion 5c in a vertical direction and the thick elastic working portion 5i has a tip taking a bulged shape.

The elastic working portion 5i comes in slidable contact with an inner peripheral surface 6b of the cylinder portion 6a.

A concave portion 30a is formed on the front side of the cap nut 30. A bearing 31 and an annular elastic seal portion 5′ are inserted into the concave portion 30a.

The annular elastic seal member 5′ is formed of hard rubber and includes the thick elastic working portion 5i, the attachment portion 5b, a coupling portion 5j,and the thin intermediate portion 5d between the elastic working portion 5i and the attachment portion 5b.

The thick elastic working portion 5i has a tip taking a bulged shape.

The attachment portion 5j is protruded in a horizontal direction with respect to the attachment portion 5b, and the intermediate portion 5d is protruded from the coupling portion 5j in an oblique direction.

The bearing 31 and the thick elastic working portion 5i come in contact with the outer periphery of the large diameter portion 1a of the spool shaft 1.

The base end of the rotary shaft cylinder 28 is rotatably supported on a bearing portion 6c. A driving gear 32 is mated with a pinion 28b formed integrally with the front side of the base end so that the rotor 29 is supported and rotates in conjunction with the rotation of a handle 33.

A rotary shaft 32a of the driving gear 32 is supported on opposite side walls of the reel body 6 through a bearing which is not shown, and a handle shaft 34 having the handle 33 fixed thereto is inserted and fitted in the central polygonal hole of the rotary shaft 32a to be freely exchanged on the right and left.

The large diameter portion 1a of the spool shaft 1 in which a spool 2′ is fixed to a tip thereof is slidably inserted in the central hole of the rotary shaft cylinder 28 for a reciprocating motion in a longitudinal direction. The bearing 31 is fitted in the large diameter portion 1a. A slider 35 is attached to the outer periphery of a rear side portion 1e of the spool shaft 1 through an engagement plate 36.

An interlocking gear 37 is engaged with the rotary shaft cylinder 28 on the front side of the pinion 28b of the rotary shaft cylinder 28 in the reel body 6.

A traverse cam shaft 38 of a sliding mechanism is inserted and supported in the bearing portion 6c and a shaft hole 6d formed on the rear side of the reel body 6 in parallel with the spool shaft 1.

A small gear 39 is swiveled, locked and fitted in the tip of the traverse cam shaft 39 and is mated with the interlocking gear 37.

The slider 35 is fitted in the traverse cam shaft 38. A click of an engagement member 40 provided on the slider 35 is fitted in a traverse cam groove.

The large diameter portion 1a of the spool shaft 1 is provided with a step portion if. The spool 1 includes a tip small diameter portion 1g protruded therefrom, an engagement portion 1h, a peripheral groove 1i and an inclined surface 1j having a trapezoidal portion over the outer periphery thereof. An extended portion 1k and an engagement portion 1m are formed in a rear side portion 1e of the spool shaft.

The spool 2′ comprises a line winding drum portion 2h, a front flange portion 2i, a rear cylinder portion 2j having a large diameter, a front concave portion 2m,a central through hole 2n, a female screw 2o of the concave portion 2m, and a rear face 2p in the cylinder portion 2j.

The small diameter portion 1g of the spool shaft 1 is slidably fitted in a bearing sleeve 41 which is fitted and fixed into the central through hole 2n of the spool 2′. The spool 2′ is prevented from slipping off by effecting the peripheral groove 1i and a spring 42. The spring 42 has two parallel bent and circumferential portions formed integrally like a clip.

Furthermore, a ratchet gear 43 and a washer 44 are fitted in the small diameter portion 1g and are interposed between the step portion 1f and the rear face 2p of the spool 2′.

The spring 42 is inserted in the front concave portion 2m to be freely movable in a circumferential direction and a washer 45 is inserted therein. A male screw of a cap 46 is screwed to the female screw 2o of the concave portion 2m.

A press button 47 is fitted in a cylinder hole 46a of the cap 46 to be movable longitudinally, and an engagement portion 46b including several axial grooves is formed on one of sides in the cylinder hole 46a of the cap 46.

The press button 47 has an outer peripheral cylinder portion 47a fitted in the cylinder hole 46a and an engagement portion 47b protruded and formed in the cylinder portion 47a and engaged with the engagement portion 46b.

A cylinder portion 47c is protruded from the rear portion of the press button 47 and a peak portion 47e is formed by inclined faces 47d and 47d in upper and lower parts of the cylinder portion 47c.

The tip of the peak portion 47e is formed to have a smaller space than that of the two parallel bent portions of the spring 42.

The rotor 29 is attached to the rotary shaft cylinder 28 through the cylinder portion 29a, and is comprises the cylinder portion 29a, a front wall 29c, a cylinder potion 29d having a large diameter and a pair of support arms 29g and 29h protruded forward from the outer periphery of base portions 29e and 29f of the cylinder portion 29d having a large diameter.

A bail support member 48 and a bail support member 49 are pivotally supported with a screw on the outside of the tip portions of the bail support arms 29g and 29h to be freely inverted into a line winding position and a line release position.

A bail attachment portion 50 and a line guide roller 51 which constitute a line guiding portion C are fixed to the tip of the bail support member 48.

A bail 52 is provided between the bail attachment portion 50 and the bail support member 49.

Cylinder portions 6f and 6g are protruded rearward from a rear side wall 6e of the reel body 6.

A waterproof sliding contact portion 6h constituted by the inner periphery of a concave portion is formed on the outside of the cylinder portion 6f.

A hole 6i is formed on the rear side wall 6e and one of the ends of a braking metal member 7 is fitted therein.

A two-stripe groove portion 6j and a screw portion 6k are formed in the cylinder portion 6f in an axial direction.

A through hole 6m is formed on the open end side of the cylinder portion 6f perpendicular to the axial direction.

An engagement through hole 7a is formed on the center of the braking metal member 7. A flange portion 7c is formed in an outer peripheral portion 7b. An engagement portion which is not shown is formed on the rear side of the flange portion 7c.

The spool shaft 1 has an extended portion 1k formed on the rear part of the rear side portion 1e, the engagement portion 1m formed on the outer periphery of the extended portion 1k. The extended portion 1k is fitted in the engagement through hole 7a to be longitudinally movable.

A friction plate 11 of a braking member A is fitted in close contact with the outer peripheral portion 7b on the front side of the flange portion 7c, the friction plate 11 and braking plates 12 and 13 are fitted in the outer peripheral portion 7b on the rear side of the flange portion 7d, and the braking plate 13 is engaged with and prevented from rotating with respect to an engagement portion 7d.

A convex portion formed on the outer periphery of the braking plate 12 is engaged with and prevented from rotating with respect to the two-stripe groove portion 6j.

A press ring 53 and a spring 26 are caused to abut on the braking plate 12 on the rear side, and a press member 8 screwed to the screw portion 6k is caused to abut on the press ring 53 and the spring 26.

The press member 8 comprises a cylinder portion 8b, having a large diameter which is provided with a screw portion 8a on the outer periphery, a cylinder portion 8e having an intermediate diameter and including outer and inner step portions 8c and 8d, a screw portion 8f on the inner periphery of the cylinder portion 8e, a small diameter portion 8g in a step portion on the rear side of the cylinder portion 8e, an engagement convex portion 8h in a step position, and a holding portion 8i for an O ring 54 in a rear part on the rear end of the cylinder portion 8e.

The engagement convex portion 8h is formed to have a plurality of projections toward the rear side over the circumference.

An inside cylinder portion 4f of a drag regulating member 4′ is fitted in the outer periphery of the small diameter portion 8g.

The drag regulating member 4′ comprises the inside cylinder portion 4f, an engagement concave portion 4g formed on the tip of the inside cylinder portion 4f, an outside cylinder portion 4h coupled to the inside cylinder portion 4f, a click gear portion 4i formed on the inner periphery of the outside cylinder portion 4h, and an engagement concave portion 4j formed on the outer periphery of the tip on the front side of the outside cylinder portion 4h.

The engagement concave portion 4g is engaged with the engagement convex portion 8h.

An O ring 54 is pressed by a flange portion 55a of a screw plug 55 screwed to the screw portion 8f and the inside of the cylinder portion 6f is water resistant.

The screw plug 55 comprises a flange portion 55a,a cylinder portion 55b and a screw portion 55c provided on the outer periphery of the cylinder portion 55b.

A click spring 56 is inserted in the through hole 6m, and a click portion 56a is engaged with the click gear portion 4i.

The attachment portion of an annular elastic seal member 5″ is fitted in the engagement concave portion 4j of the drag regulating member 4′.

The annular elastic seal member 5″ is formed of hard rubber and includes a thick elastic working portion 5i,an attachment portion 5b, and a thin intermediate portion 5d between the elastic working portion 5i and the attachment portion 5b. The elastic working portion 5i and the intermediate portion 5d are protruded from the attachment portion 5b in a perpendicular direction.

The tip of the thick elastic working portion 5d is formed to take a bulged shape.

The tip of the thick elastic working portion 5i comes in slidable contact with a waterproof sliding portion 6h of the reel body 6 which is one of the opposed members, and an attachment portion 5f is fitted in the engagement concave portion 4j of the drag regulating member 4′ which is the other opposed member.

The intermediate portion 5d is so formed as to permit the deformation of the elastic working portion 5i during the contact.

In the tenth embodiment, drag braking force is regulated in the following manner. When the drag regulating member 4′ is rotated, the press member 8 is moved longitudinally in the axial direction and is moved forward, the friction plate 11 and the flange portion 7c, the friction plate 11 and the braking plates 12 and 13, and the press ring 53 and the coil-shaped spring 26 in the braking member A are pressed so that the braking force is regulated to be increased.

When the drag regulating member 4′ is rotated, the elastic working portion 5i of the annular elastic seal member 5 is permitted to be deformed by the deformable intermediate portion 5d, slidably comes in contact with the waterproof sliding contact portion 6h and is thus moved forward and backward so that water can be prevented from entering the drag regulating member 4′.

To remove the spool 2′ from the spool shaft 1, the press button 47 is pressed down and the spring 42 is expanded by the inclined faces 47d and 47d on the front side of the peak portion 47e so that the spool 2′ can be removed.

In the tenth embodiment, the elastic working portion 5i of the annular elastic seal member 5 slidably comes in contact with the inner peripheral surface 6b of the cylinder portion 6a on the front side of the reel body 6 at the fixing side, and the attachment portion 5b is fitted in the cylinder portion 29a of the rotor 29 on the rotation side.

The elastic working portion 5i of the annular elastic seal member 5′ slidably comes in contact with the large diameter portion 1a of the spool shaft 1 on the fixing side and the attachment portion 5b is fitted in the cap nut 30 on the rotation side.

Furthermore, the elastic working portion 5i of the annular elastic seal member S″ slidably comes in contact with the inner peripheral surface 6h of the cylinder portion 6g on the rear side of the reel body 6 at the fixing side, and the attachment portion 5f is fitted in the regulating member 4′ on the rotation side.

The thin intermediate portion 5d is provided between the elastic working portion 5i and the attachment portion 5b in each of the annular elastic seal members 5, 5′ and 5″. Therefore, even if a deflection or eccentricity is present between the fixing side and the rotation side, the thick elastic working portion 5i easily conforms to the rotor and the contact pressure of the elastic working portion 5i can be reduced. Therefore, a rotation resistance is reduced and the rotor can be rotated smoothly, and a light rotation performance and a high waterproof performance can be obtained.

If a high waterproof performance can be obtained, the water can be prevented from entering the bearing 27 and the reel body 6, the braking member A and the bearing 31.

### Eleventh Embodiment

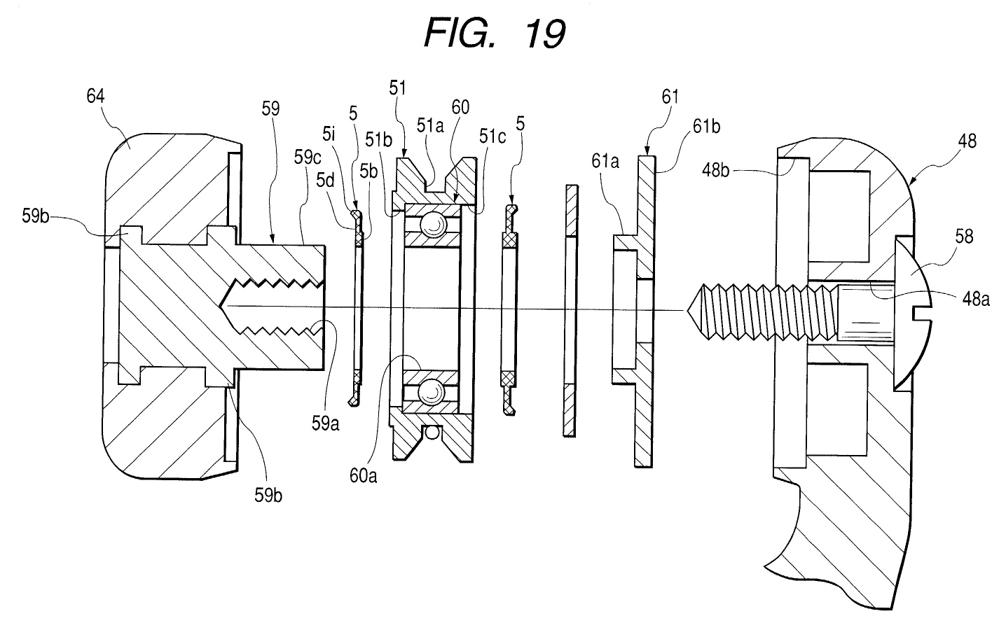

FIGS. 18 and 19 show an eleventh embodiment. FIG. 18 is a sectional side view showing the line guide portion of a fishing spinning reel according to the eleventh embodiment and FIG. 19 is an exploded sectional side view showing the line guide portion.

In the eleventh embodiment, a line guide portion C for guiding a line 57 to a spool 2′ is provided on the tip of the bail support member 48 according to the tenth embodiment.

In the line guiding portion C, a hole 48a is formed on the bail support member 48, and a screw 58 inserted in the hole 48a is screwed into a screw hole 59a formed in a shaft portion 59 of a bail attachment portion 50 so that the bail attachment portion 50 is fixed.

The screw hole 59a is formed on the center of the shaft portion 59. An engagement portion 59b comprising a step portion and a small diameter portion 59c are formed on the outer periphery of the shaft portion 59. An annular elastic seal member 5 having the same shape as that of the fifth embodiment, an inner ring 60a of a ball bearing 60, the annular elastic seal member 5 and a cylindrical engagement portion 61a of an engagement member 61 are fitted in the outer periphery of the small diameter portion 59c.

The bail attachment portion 50 is formed by the shaft portion 59 and an armor portion 64 which is outsert molded in the outside on one of sides of the shaft portion 59.

The engagement member 61 is formed by a cylindrical engagement portion 61a fitted and fixed into the outer periphery of the small diameter portion 59c of the bail attachment portion 50 and a flange portion 61b to abut on the bottom surface of a concave portion 48b of the bail support member 48.

A line guide roller 51 is provided with a small groove-shaped line guide portion 51a on the outer periphery thereof.

The annular elastic seal member 5 includes an elastic working portion 5i, an attachment portion 5b and a thin intermediate portion 5d provided therebetween. The elastic working portion 5i and the intermediate portion 5d are protruded from the attachment portion 5b in a vertical direction.

The tip of the thick elastic working portion 5i is formed to have a bulged shape.

The thick elastic working portion 5i slidably comes in contact with the inner peripheral surfaces of a hole 51b having a small diameter and a hole 51c having a large diameter in the line guide roller 51.

In the eleventh embodiment, the elastic working portion 5i of the annular elastic seal member 5 is caused to slidably come in contact with the inner peripheral surfaces of the small and large holes 51b and 51c in the line guide roller 51, and the attachment portion 5b is fitted in the shaft portion 59 of the bail attachment portion 50 and the thin intermediate portion 5d is provided between the elastic working portion 5i and the attachment portion 5b. Therefore, even if a deflection or eccentricity is present between the fixing side and the rotation side, the thick elastic working portion 5i easily fits to the rotor so that the contact pressure of the elastic working portion 5i can be reduced. Therefore, a rotation resistance is reduced and the rotor can be rotated smoothly, and a light rotation performance and a high waterproof performance can be obtained.

If a high waterproof performance can be obtained, the water can be prevented from entering the ball bearing 60.

### Twelfth Embodiment

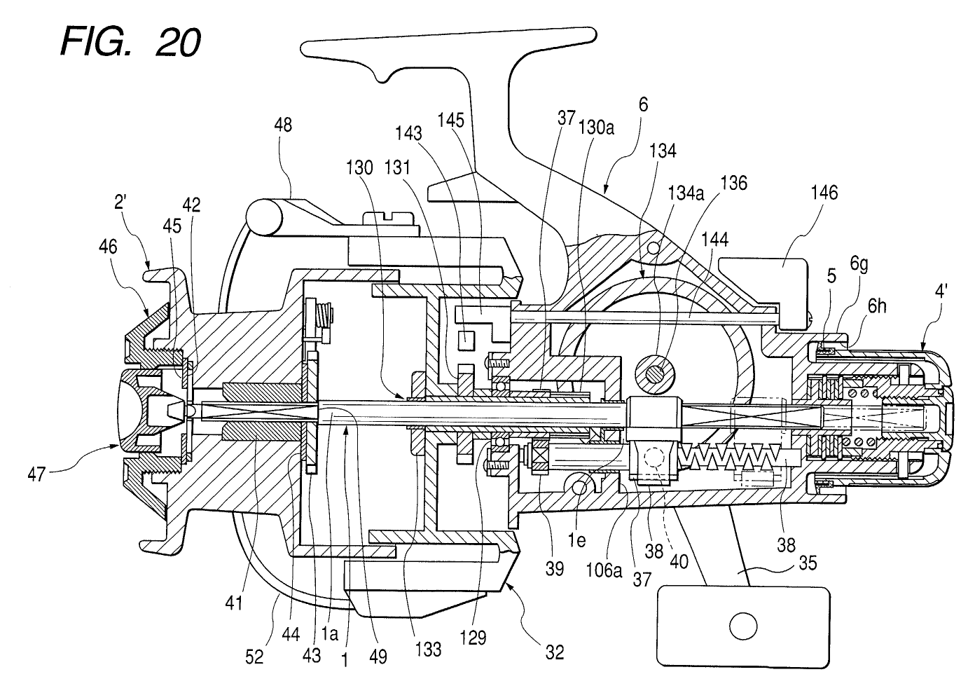

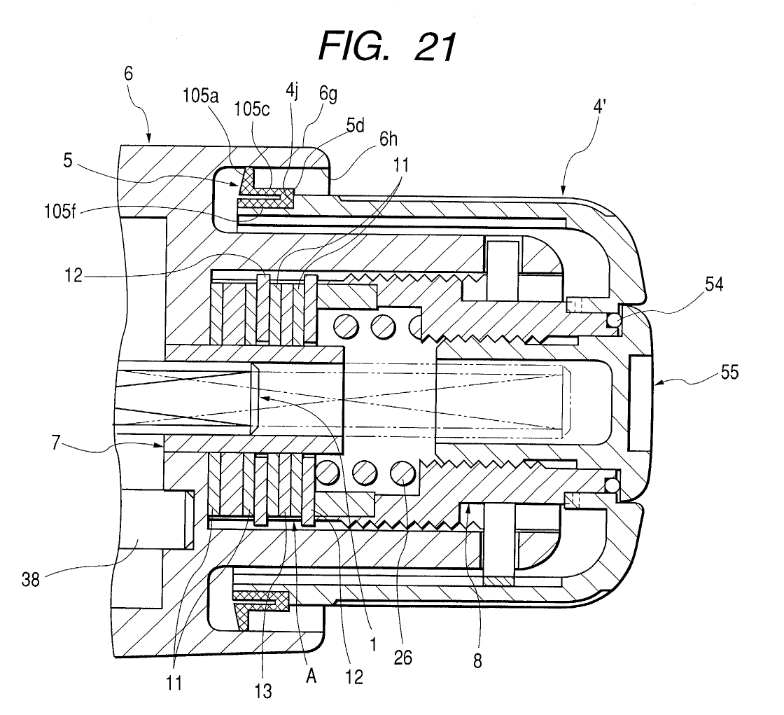

FIGS. 20 and 21 show a fishing reel using a rear drag method according to a twelfth embodiment. FIG. 20 is a sectional side view showing a fishing spinning reel and FIG. 21 is an enlarged sectional side view showing a rear side reel body and a drag regulating member.

In the fishing spinning reel, a rotary shaft cylinder 130 is rotatably received by a bearing 129 on the front side of a reel body 6 and is protruded forward.

A reverse rotation preventing ratchet wheel 131 and a rotor 32 are engaged with and prevented from rotating with respect to the outer periphery of the rotary shaft cylinder 130 on the front side of the bearing 129. The rotor 32 is fixed with a nut 133.

The base end of the rotary shaft cylinder 130 is rotatably supported on a bearing portion 106a. A driving gear 134 is mated with a pinion 130a formed integrally with the front side of the base end so that a rotor 32 is supported and rotates in conjunction with the rotation of a handle 35.

A rotary shaft 134a of the driving gear 134 is pivotally supported on opposite side walls of the reel body 6 through a bearing which is not shown, and a handle shaft 136 having the handle 35 fixed thereto is inserted and fitted in the central polygonal hole of the rotary shaft 134a to be freely exchanged on the right and left.

A large diameter portion 1a of a spool shaft 1 in which a spool 2′ is fixed to a tip thereof is slidably inserted in the central hole of the rotary shaft cylinder 130 for reciprocating motion in a longitudinal direction, and a slider 37 is fixed to the outer periphery of a rear side portion 1e of the spool shaft 1 with an engagement plate 38.

A reverse rotation preventing click 143 is caused to removably face the reverse rotation preventing ratchet wheel 131.

A reverse rotation preventing cam 145 is attached to the front side of an operation beam 144 which is rotatably fixed to the reel body 6 and an operation knob 146 is attached to the operation beam 144 protruded outward from the rear side of the reel body 6.

An annular elastic seal member 5 is formed of hard rubber and includes a hook-shaped first elastic working portion 105a, an attachment portion 105f, a thin second elastic working portion 105c between the first elastic working portion 105a and the attachment portion 105f, and a thick coupling portion 105d between the first elastic working portion 105a and the second elastic working portion 105c.

The tip of the first elastic working portion 105a is caused to slidably come in contact with a waterproof sliding contact portion 6h of the reel body 6 which is one of opposed members, and the attachment portion 105f is fitted in an engagement concave portion 4j of a drag regulating member 4′ which is the other opposed member.

The second elastic working portion 105c is so formed as to permit the deformation of the first elastic working portion 105a during the contact.

Other structures are almost the same as those in the tenth embodiment.

### Thirteenth Embodiment

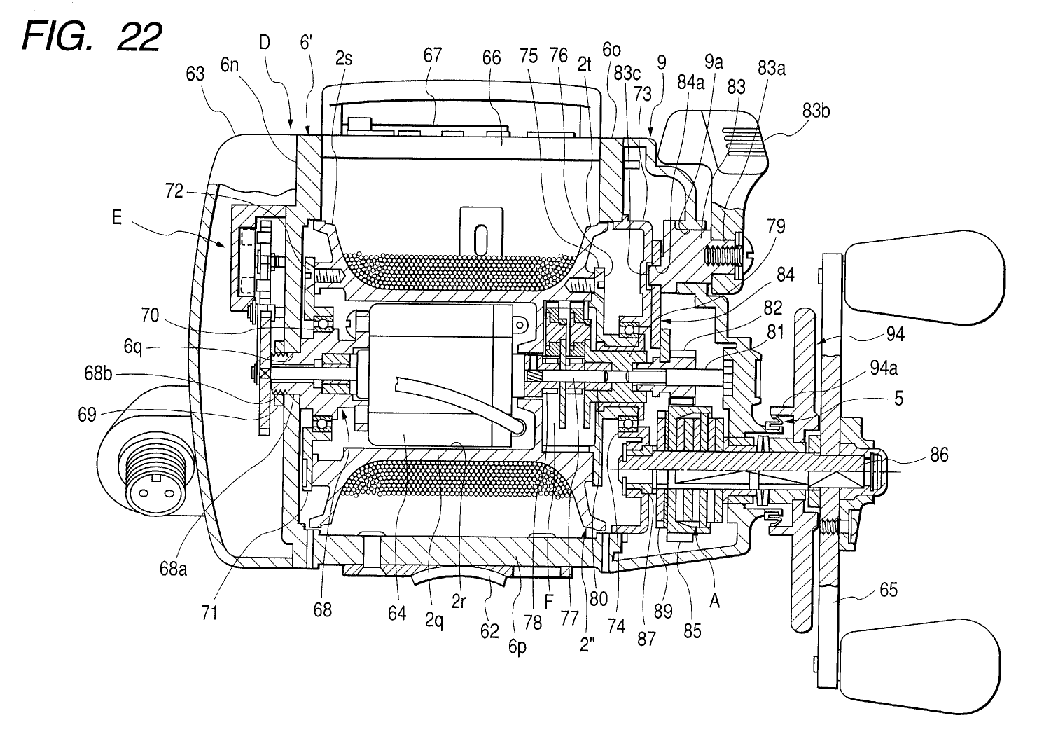

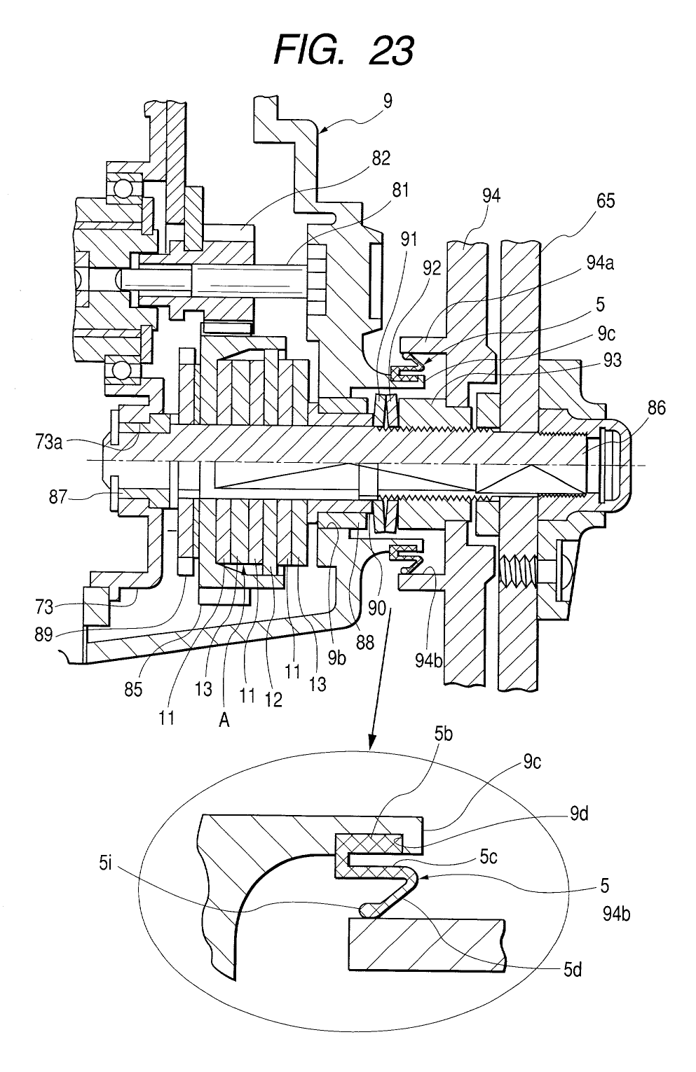

FIGS. 22 and 23 show a double bearing type motor reel for a fishing reel according to a thirteenth embodiment. FIG. 22 is a sectional rear view showing a motor reel and FIG. 23 is an enlarged sectional rear view showing the motor reel on the handle side and a sectional rear view showing the main part thereof.

In a reel body D of the motor reel, left and right side frames 6n and 6o of a side frame 6′, a strut and a finger mounting plate which are not shown, and a fixed plate 6n of a reel leg 62 are provided integrally. The left and right side frames 6n and 6o are held in parallel with each other. Aide plates 63 and 9 of the reel body D are attached to the outside of left and right side frames 6n and 6m, respectively.

A spool 2″ is rotatably supported between the opposite inner side frames 6n and 6o of the side plates 63 and 9. An electric motor 64 is provided in a drum portion 2r of a line winding portion 2q of the spool 2″. The spool 2″ is rotated with a handle 65 provided outside the side plate 9 and the electric motor 64.

A control box 66 accommodating a control circuit and motor control device for the electric motor 64 is mounted and attached onto the left and right side plates 6n and 6o in the upper front region of the spool 2″.

A liquid crystal display portion 67 for displaying a line length measured by a line length measuring device E provided on the right side of the left side frame 6n and other display and operation buttons for various function switches are provided on the control box 66.

In the motor reel, a shaft portion 68a of a fixing member 68 is inserted in a central hole 6p of the left side frame 6n. A nut 69 is screwed into a male screw 68b of the fixing member 68 so that the fixing member 68 is fixed to the side frame 6n.

One of the sides of a motor body of the electric motor 64 is fixed to the fixing member 68. A bearing portion of a rotary disk-shaped support portion 71 is rotatably supported on the outer periphery of the fixing member 68 through a ball bearing 70.

The rotary disk-shaped support portion 71 is fixed with a screw 72 to a flange portion 2s on one of the sides of the spool 2″.

A rotary disk-shaped inside plate 73 is fixed to the side frame 6o in the side plate 9. A rotary disk 75 is rotatably held in the inside plate 73 through a ball bearing 74. An other side flange portion 2t of the spool 2″ is fixed to the rotary disk 75 with a screw 76.

Accordingly, in the spool 2″, the rotary disk-shaped support portion 71 fixed to one of the sides and the rotary disk 75 fixed to the other side are rotatably held in the fixing member 68 and the rotary disk-shaped inside plate 73 through the ball bearings 70 and 74, respectively. The fixing member 68 and the inside plate 73 are fixed to the left side frame 6n and the right side frame 6o, respectively.

A driving mechanism F comprising a planet gear is accommodated in a cavity portion on the other side of the spool 2″. A pinion 78 is fixed to a rotary shaft 77 protruded from the other side of the electric motor 64 and is mated with a gear of the driving mechanism F.

The output of the driving mechanism F is transmitted to a rotor 79 fitted in the center of the rotary disk 75. A metal bearing 80 is fixed to the center on one of the sides of the rotor 79. A support shaft 81 fixed to the rotary shaft 77 and the side plate 9 is fitted in the central holes of the metal bearing 80 and the rotor 79, respectively.

A driving pinion 82 is fitted in the outer periphery of the support shaft 81. A clutch portion formed on the driving pinion 82 and the rotor 79 is engageable with or disengageable from each other, thereby carrying out an engaging and disengaging operation through an operation lever of a clutch operation member 83.

A hole 9a is formed on the side plate 9 and the clutch operation member 83 is rotatably fitted therein.

The clutch operation member 83 is provided with a rotating portion 83a and an operation lever 83b which is attached integrally with the rotating portion 83a protruded outward from the hole 9a of the side plate 9.

A pin 83c is fixed to the rotating portion 83a in the side plate 9 and is inserted in an engagement portion 84a to be a slot of a clutch operation plate 84.

A driving gear 85 is mated with the driving pinion 82 and is thus coupled frictionally to a handle shaft 86 through a braking member A, and the handle shaft 86 is rotatably supported on the rotary disk-shaped inside plate 73 and the side plate 9 and a handle 65 is attached to the handle shaft 86 protruded from the side plate 9.

The driving gear 85 is fitted in the handle shaft 86 rotatably and movably in an axial direction and is frictionally coupled through braking plates 12 and 13 to a friction plate 11 accommodated in the concave portion of the driving gear 85.

The handle shaft 86 has one of the ends attached through a metal bearing 87 to a hole 73a of the disk-shaped inside plate 73 of the right side frame 6o and the other end pivotally supported through a bearing 88 fitted in a hole 9b of the side plate 9.

A ratchet wheel 89, the braking plate 12 and a press member 90 are engaged with and prevented from rotating with respect to the handle shaft 86. The driving gear 85, the friction plate 11, the braking plate 13 and springs 91 and 92 are rotatably fitted therein.

The braking plate 12 is engaged with and prevented from rotating with respect to the driving gear 85.

A screw portion is formed in the handle shaft 86 and a nut 93 is screwed thereto, and a drag braking regulation knob 94 is engaged with and prevented from rotating with respect to the outer periphery of the nut 93.

A cylinder portion 94a is formed on the drag braking regulation knob 94 toward the side plate 9 side. The inner periphery of the cylinder portion 94a is formed in a waterproof sliding portion 94b.

An engagement concave portion 9d is formed on the outer periphery of the outside of a cylinder portion 9c protruded outward from the hole 9b of the side plate 9 and an attachment portion of an annular elastic seal member 5 is fitted in the engagement concave portion 9d.

The annular elastic seal member 5 has a similar shape to that of one of the annular elastic seal members 5 according to the tenth embodiment and is formed of hard rubber and includes a thick elastic working portion 5i, an attachment portion 5b, a coupling portion 5c, and a thin intermediate portion 5d between the elastic working portion 5i and the attachment portion 5b.

The thick elastic working portion 5i and the thin intermediate portion 5d are formed to have an inverted conical shape with respect to the coupling portion 5c in a vertical direction. The thick elastic working portion 5i has a tip taking a bulged shape.

The tip of the elastic working portion 5i is caused to slidably come in contact with the waterproof sliding portion 94b of the drag braking regulation knob 94 which is one of the opposed members and the attachment portion 5b is fitted in the engagement concave portion 9d of the side plate 9 which is the other opposed member.

The intermediate portion 5d is formed thinly to permit the deformation of the elastic working portion 5i during the contact.

In the thirteenth embodiment, drag braking force is regulated in the following manner. When the drag braking regulation knob 94 is rotated, the nut 93 is moved longitudinally in the axial direction and is moved forward, the springs 91 and 92, the press member 90, and the friction plate 11 and the braking plates 12 and 13 in a braking member A are pressed in the direction of the driving gear 85 so that the braking force is regulated to be increased.

Furthermore, when the drag braking regulation knob 94 is rotated, the elastic working portion 5i of the annular elastic seal member 5 is permitted to be deformed by the deformable intermediate portion 5d, slidably comes in contact with the waterproof sliding contact portion 94b and is thus moved forward and backward so that water can be prevented from entering the driving gear 85 in the side plate 9.

### Fourteenth Embodiment

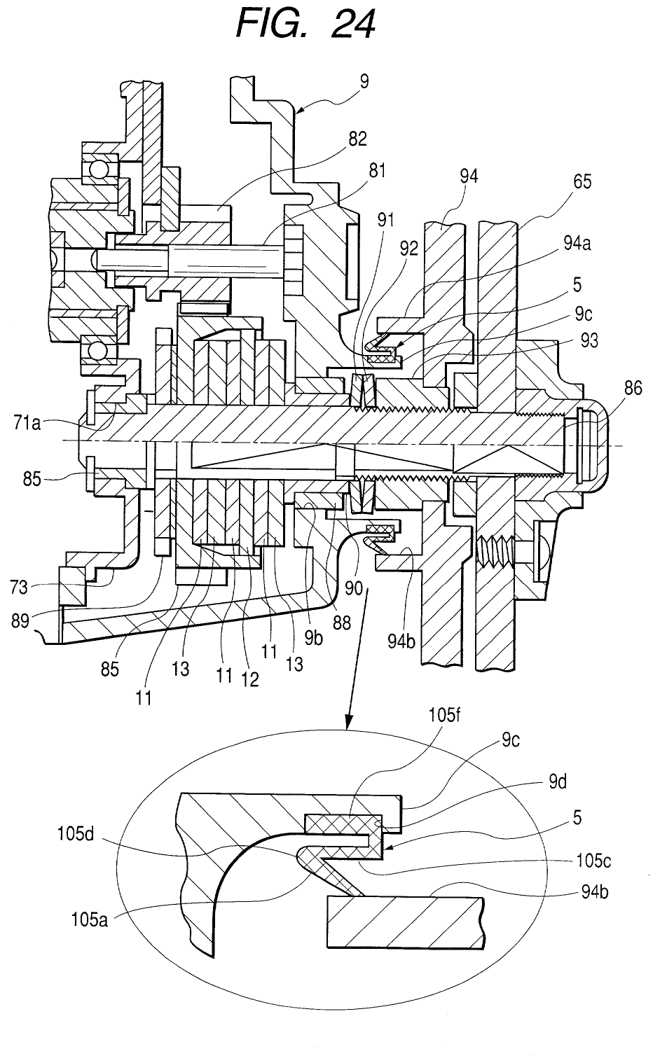

FIG. 24 shows a double bearing type motor reel for a fishing reel according to a fourteenth embodiment. FIG. 24 is an enlarged sectional rear view showing the motor reel on the handle side and a sectional rear view showing the main part thereof.

An annular elastic seal member 5 is formed of hard rubber and includes a hook-shaped first elastic working portion 105a, an attachment portion 105f, a thin second elastic working portion 105c between the first elastic working portion 105a and the attachment portion 105f, and a thick coupling portion 105d between the first elastic working portion 105a and the second elastic working portion 105c.

The tip of the first elastic working portion 105a is caused to slidably come in contact with a waterproof sliding contact portion 92b of a drag braking regulation knob 92 which is one of opposed members, and the attachment portion 105f is fitted in an engagement concave portion 9d of a side plate 9 which is the other opposed member.

The second elastic working portion 105c is formed to permit the deformation of the first elastic working portion 10a during the contact.

In the first embodiment to the fifth embodiment, elastic working portions 5a, 5e, 5f, 5g and 5i of annular elastic seal members 5, 5′ and 5″ are formed thickly and intermediate portions 5d and 5h are formed more thinly than the elastic working portions 5a, 5e, 5f, 5g and 5i and an attachment portion 5b. Consequently, even if a deflection or eccentricity is present between one opposed member 4 on the fixing side where the attachment portion 5b is fixed and the inner peripheral surface of the edge portion of the other opposed member 18 to be a rotor on the sliding side with which the elastic working portions 5a, 5e, 5f, 5g and 5i are caused to slidably come in contact, the thick elastic working portions 5a, 5e, 5f, 5g and 5i easily conform to the rotor and the contact pressures of the elastic working portions 5a, 5e, 5f, 5g and 5i can be reduced. Therefore, a rotation resistance can be reduced and the rotor can be rotated smoothly so that a light rotation performance and a high waterproof performance can be obtained.

In the tenth embodiment, the elastic working portion 5i of the annular elastic seal member 5 is caused to slidably come in contact with an inner peripheral surface 6b of a cylinder portion 6a on the front side of a reel body 6 on the fixing side and the attachment portion 5b is fitted in a cylinder portion 29a of a rotor 29 on the rotation side.

The elastic working portion 5i of the annular elastic seal member 5′ is caused to slidably come in contact with a large diameter portion 1a of a spool shaft 1 on the fixing side and the attachment portion 5b is fitted in a cap nut 30 on the rotation side.

Furthermore, the elastic working portion 5i of the annular elastic seal member 5″ is caused to slidably come in contact with an inner peripheral surface 6h of a cylinder portion 6g on the rear side of the reel body 6 on the fixing side and the attachment portion 5b is fitted in a regulating member 4′ on the rotation side.

The thin intermediate portion 5d is provided between the elastic working portion 5i of each of the annular elastic seal members 5, 5′ and 5″ and the attachment portion 5b. Therefore, even if a deflection or eccentricity is present between the fixing side and the rotation side, the thick elastic working portion 5i easily conforms to the rotor and the contact pressure of the elastic working portion 5i can be reduced. Therefore, a rotation resistance is reduced and the rotor can be rotated smoothly, and a light rotation performance and a high waterproof performance can be obtained.

In the seventh embodiment, the elastic working portion 5i of the annular elastic seal member 5 is caused to slidably come in contact with the inner peripheral surfaces of large and small holes 51b and 51c of a line guide roller 51 and the attachment portion 5b is fitted in a shaft portion 59 of a bail fixing portion 50 and the thin intermediate portion 5d is provided between the Solo elastic working portion 5i and the attachment portion 5b. Therefore, even if a deflection or eccentricity is present between the fixing side and the rotation side, the thick elastic working portion 5i easily conforms to the rotor and the contact pressure of the elastic working portion 5i can be reduced. Therefore, a rotation resistance is reduced and the rotor can be rotated smoothly, and a light rotation performance and a high waterproof performance can be obtained.

In the thirteenth embodiment, the elastic working portion 5i of the annular elastic seal member 5 is caused to slidably come in contact with a waterproof sliding contact portion 94b of a cylinder portion 94a of a drag braking regulation knob 94 on the rotation side and the attachment portion 5b is fitted in a cylinder portion 9c of a side plate 9 so that the thin intermediate portion 5d is provided between the elastic working portion 5i and the attachment portion 5b. Therefore, even if a deflection or eccentricity is present between the fixing side and the rotation side, the thick elastic working portion 5i easily conforms to the rotor and the contact pressure of the elastic working portion 5i can be reduced. Therefore, a rotation resistance is reduced and the rotor can be rotated smoothly, and a light rotation performance and a high waterproof performance can be obtained.

Further, the intermediate portions 5d and 5h are formed more thinly than the elastic working portions 5a, 5e, 5f, 5g and 5i and the attachment portion 5b. Consequently, the eccentricity or deflection between the elastic working portions 5a, 5e, 5f, 5g and 5i and the attachment portion 5b can be removed more effectively. Even if the contact pressure is reduced, the elastic working portion can conform to the rotor more easily.

In the sixth embodiment to the ninth embodiment, the twelfth embodiment and the fourteenth embodiment, the second elastic working portion 5c and the second elastic working portion 27 are formed to permit the deformation of the first elastic working portion 5a during the contact. Therefore, the deflection or deformation generated between one of the opposed members and the other opposed member can be absorbed by the elastic deforming action of the second elastic working portions 5c, 5e and 27 formed in the intermediate portion of the elastic seal member 5. Consequently, it is possible to obtain a light rotation performance and a high waterproof performance between the members.

Further, the second elastic working portion 5c is formed thinly and can permit the deformation of the first elastic working portion 5a during the contact. Therefore, a contact pressure of the first elastic working portion 5a to the peripheral surface of the member can be sufficiently maintained and a stable waterproof performance can be obtained.

Further, if a high elastic member 28 such as a metal member is insert molded in a thick coupling portion 5d of the first elastic working portion 5a and the second elastic working portion 5c, the contact pressure of the first elastic working portion 5a to the peripheral surface of the member can be sufficiently maintained and a stable waterproof performance can be obtained.

The invention is carried out in the configuration described above and can produce the following effects.

According to the present invention, the elastic working portion of the annular elastic seal member is formed thickly and the intermediate portion is formed more thinly than the elastic working portion and the attachment portion. Consequently, even if a deflection or eccentricity is present between one opposed member on the fixing side where the attachment portion is fixed and the inner peripheral surface of the edge portion of the other opposed member to be a rotor on the sliding side with which the elastic working portion is caused to slidably come in contact, the thick elastic working portion easily conforms to the rotor and the contact pressure of the elastic working portion can be reduced. Therefore, a rotation resistance can be reduced and the rotor can be rotated smoothly so that a light rotation performance and a high waterproof performance can be obtained.

According to the present invention, the intermediate portion is formed more thinly than the elastic working portion and the attachment portion. Consequently, the eccentricity or deflection caused between the elastic working portion and the attachment portion can be removed more effectively. Even if the contact pressure is reduced, the elastic working portion can conform to the rotor more easily.

According to the present invention, the second elastic working portion is so formed as to permit the deformation of the first elastic working portion during the contact. Therefore, the deflection or deformation generated between one of the opposed members and the other opposed member can be absorbed by the elastic deforming action of the second elastic working portion formed in the intermediate portion of the elastic seal member. Consequently, it is possible to obtain a light rotation performance and a high waterproof performance between the members.

According to the present invention, the second elastic working portion is formed thinly and can permit the deformation of the first elastic working portion during the contact. Therefore, a contact pressure of the first elastic working portion to the peripheral surface of the member can be sufficiently maintained and a stable waterproof performance can be obtained.

According to the present invention, if a high elastic member such as a metal member is insert molded in the thick coupling portion of the first elastic working portion and the second elastic working portion, the contact pressure of the first elastic working portion to the peripheral surface of the member can be sufficiently maintained and a stable waterproof performance can be obtained.

What is claimed is

1. A fishing reel having an elastic seal member for preventing liquid from entering provided between opposed members of the fishing reel, the elastic seal member comprising:
an elastic working portion which comes in contact with one of the opposed members;
an attachment portion attached to the other opposed member; and
an intermediate portion between the elastic working portion and the attachment portion,
wherein the elastic working portion is formed more thickly than at least the intermediate portion.

2. The fishing reel according to claim 1, wherein the intermediate portion is formed thinly.

3. The fishing reel according to claim 1, wherein the elastic seal member is formed of hard rubber.

4. The fishing reel according to claim 1, wherein the elastic seal member is annular.

5. The fishing reel according to claim 1, wherein the elastic seal member includes a coupling portion between the intermediate portion and the attachment portion, and the coupling portion makes an acute angle with the intermediate portion.

6. The fishing reel according to claim 1, wherein the intermediate portion includes a bellows shape portion.

7. The fishing reel according to claim 1, wherein a tip of the elastic working portion is formed in a bulged shape.

8. A fishing reel having an elastic seal member for preventing liquid from entering provided between opposed members of the fishing reel, the elastic seal member comprising:
a first elastic working portion which comes in contact with one of the opposed members;
an attachment portion attached to the other opposed member; and
a second elastic working portion between the first elastic working portion and the attachment portion, which permits deformation thereof during the contact.

9. The fishing reel according to claim 8, wherein the second elastic working portion is formed thinly.

10. The fishing reel according to claim 8, wherein a high elastic portion is formed between the first elastic working portion and the second elastic working portion.

11. The fishing reel according to claim 8, wherein the elastic sealing member is annular.

12. The fishing reel according to claim 8, wherein the elastic sealing member is formed of hard rubber.

13. The fishing reel according to claim 8, wherein the first elastic working portion makes an acute angle with the second elastic working portion.

14. The fishing reel according to claim 8, wherein the second elastic working portion is formed of a softer rubber than a material of each of the first elastic working portion and the attachment portion.
